(19) United States
(12) Patent Application Publication
(10) Pub. No.: US 2016/0380673 A1
(43) Pub. Date: Dec. 29, 2016

(54) VECTORING ACROSS MULTIPLE CO BOXES/CARDS/DSLAMS EITHER OWNED BY THE SAME OPERATOR OR BY DIFFERENT OPERATORS

(71) Applicant: Ikanos Communications, Inc., Fremont, CA (US)

(72) Inventors: Debajyoti Pal, Saratoga, CA (US); Shailendra Kumar Singh, Fremont, CA (US)

(21) Appl. No.: 15/189,599

(22) Filed: Jun. 22, 2016

Related U.S. Application Data
(60) Provisional application No. 62/183,585, filed on Jun. 23, 2015.

(51) Int. Cl. H04B 3/32; H04B 3/487; H04M 11/06; H04L 25/02; H04M 3/22; H04L 12/28; H04M 3/00

(52) U.S. Cl. CPC H04B 3/32; H04L 12/2878; H04B 3/487; H04M 3/007; H04L 25/0202; H04L 25/0242; H04M 3/2209; H04M 11/062; H04Q 2201/14; H04Q 2213/1336

(57) ABSTRACT

Methods, systems, and devices are described for wired communication. In one aspect, a distribution point may use a redundant number of digital subscriber line (DSL) lines that share a same cable binder to cancel crosstalk. For example a first distribution point may use a redundant number of lines, which may be virtualized lines, to cancel interference between lines controlled by the first distribution point and lines controlled by a second distribution point. In some cases, a distribution point may share precoding and cancelling coefficients with another distribution point over a cloud network or other service to enable vectoring without sharing transmitted data between the two distribution points. That is, the first distribution point may receive information related to crosstalk between sets of CPEs without receiving data transmitted by a separate distribution point sharing the same cable binder, and use the crosstalk related information to cancel crosstalk.

### CROSS REFERENCES

The present Application for Patent claims priority to U.S. Provisional Patent Application No. 62/183,585 by Debajyoti Pal, entitled “Vectoring Across Multiple CO Boxes/Cards/DSLAMs Either Owned by the Same Operator or by Different Operators,” filed Jun. 23, 2015, assigned to the assignee hereof, and expressly incorporated by reference herein.

### BACKGROUND

Field of the Disclosure

This disclosure relates generally to vectored digital subscriber line (DSL) communications, and more particularly to methods and devices for vectoring across multiple central office (CO) boxes/cards/DSL access multiplexers (DSLAMs) either owned by the same operator or by different operators.

Description of Related Art

The rapid growth of the internet and the content available through the internet has increased the demand for high bandwidth connectivity. Digital subscriber line (DSL or xDSL) technology meets this demand by providing data service over twisted pair telephone lines. DSL can be deployed from central offices (COs), from fiber-fed cabinets located near the customer premises, or within buildings.

DSL systems typically include multiple bundles of twisted pair wires located within close proximity to each other. Because of the high frequencies involved, communication occurring on one wire may degrade or substantially disrupt communication on an adjacent wire by causing electromagnetically induced crosstalk on the adjacent wire. These crosstalk signals on neighboring wires can disrupt communications on the impacted wires. Vectoring techniques are thus used to mitigate crosstalk signals when a large number of lines are present in a DSL system.

When multiple DSLAMs serve the same cable binder, vectoring may be separately performed across all of the lines served by each DSLAM. The use of precoding and canceller matrices for vectoring may necessitate matrix coefficient exchange and real-time tone data sharing between the multiple DSLAMs. However, coefficient exchange and tone data sharing becomes problematic if there is no direct connection between different DSLAMs, especially if the DSLAMs are owned and/or operated by different operators. For example, in countries such as Japan, multiple operators may be required to use the same cable binder that is owned by a different company, and thus have subscriber lines for different operators sharing the same cable binder. In such cases, each operator performs vectoring in its own DSLAM, but may experience crosstalk from lines controlled by other DSLAMs.

### SUMMARY

A distribution point may use a redundant number of digital subscriber line (DSL) lines that share a same cable binder to cancel crosstalk. For example a first distribution point may use a redundant number of lines to cancel interference between lines controlled by the first distribution point and lines controlled by a second distribution point. The lines may be virtualized lines that are used to create a channel estimation for a number of consumer premises equipment (CPEs) in the binder, and the channel estimations may be used to remove crosstalk caused by lines associated with the second distribution point. In some cases, a distribution point may share precoding and cancelling coefficients with another distribution point over a cloud network or other service to enable vectoring without sharing transmitted data between the two distribution points. That is, the first distribution point may receive information related to crosstalk and use the crosstalk related information to cancel crosstalk between different sets of CPEs without receiving data associated with a second distribution point. The crosstalk related information may include a channel matrix, a pilot sequence assignment, a quadrant scrambler state (used in reset mode), transmit and receive synchronization information for multiple distribution points (e.g., for a first and second distribution point), and a superframe alignment and synchronization symbol index.

A method of wireline communication is described. The method may include providing service by a first distribution point to a first set of consumer premises equipment (CPEs) over a first set of lines in a binder, where the binder further includes a second set of lines associated with a second set of CPEs serviced by a second distribution point, virtualizing a third set of lines at the first distribution point corresponding to the second set of CPEs, obtaining a channel estimation for each CPE of the first set of CPEs using the first set of lines and the third set of lines, and compensating transmissions for a CPE on the first set of lines based at least in part on the channel estimation, where the compensation is to reduce crosstalk between the first set of lines and the second set of lines.

A communication device for wireline communication is described. The communication device may include means for providing service by a first distribution point to a first set of consumer premises equipment (CPEs) over a first set of lines in a binder, where the binder further includes a second set of lines associated with a second set of CPEs serviced by a second distribution point, means for virtualizing a third set of lines at the first distribution point corresponding to the second set of CPEs, means for obtaining a channel estimation for each CPE of the first set of CPEs using the first set of lines and the third set of lines, and means for compensating transmissions for a CPE on the first set of lines based at least in part on the channel estimation, where the compensation is to reduce crosstalk between the first set of lines and the second set of lines.

Another communication device for wireline communication is described. The communication device may include a processor, memory in electronic communication with the processor, and instructions stored in the memory. The instructions may be operable to cause the processor to provide service by a first distribution point to a first set of consumer premises equipment (CPEs) over a first set of lines in a binder, where the binder further includes a second set of lines associated with a second set of CPEs serviced by a second distribution point, virtualize a third set of lines at the first distribution point corresponding to the second set of CPEs, obtain a channel estimation for each CPE of the first set of CPEs using the first set of lines and the third set of lines, and compensate transmissions for a CPE on the first set of lines based at least in part on the channel estimation, where the compensation is to reduce crosstalk between the first set of lines and the second set of lines.

A non-transitory computer readable medium for wireline communication is described. The non-transitory computer-readable medium may include instructions operable to cause a processor to provide service by a first distribution point to a first set of consumer premises equipment (CPEs) over a first set of lines in a binder, where the binder further includes a second set of lines associated with a second set of CPEs serviced by a second distribution point, virtualize a third set of lines at the first distribution point corresponding to the second set of CPEs, obtain a channel estimation for each CPE of the first set of CPEs using the first set of lines and the third set of lines, and compensate transmissions for a CPE on the first set of lines based at least in part on the channel estimation, where the compensation is to reduce crosstalk between the first set of lines and the second set of lines.

Some examples of the method, communication devices, and non-transitory computer-readable medium described above may further include processes, features, means, or instructions for using the channel estimation to reduce crosstalk for each CPE from the first set of CPEs. Some examples of the method, communication devices, and non-transitory computer-readable medium described above may further include processes, features, means, or instructions for using the channel estimation to reduce crosstalk may be based at least in part on receiving crosstalk information associated with crosstalk between the first set of CPEs and the second set of CPEs.

In some examples of the method, communication devices, and non-transitory computer-readable medium described above, using the channel estimation to reduce crosstalk includes: constructing a vectoring matrix based at least in part on the virtualized lines, where the vectoring matrix includes a member of a set consisting of: a precoding matrix and a canceller matrix. In some examples of the method, communication devices, and non-transitory computer-readable medium described above, the vectoring matrix includes a block diagonal matrix.

Some examples of the method, communication devices, and non-transitory computer-readable medium described above may further include processes, features, means, or instructions for communications of the first set of CPEs may be time synchronized with communications of the second set of CPEs. In some examples of the method, communication devices, and non-transitory computer-readable medium described above, the first set of CPEs may be associated with a first operator and the second set of CPEs may be associated with a second operator.

A method of wireline communication is described. The method may include providing service by a first distribution point to a first set of consumer premises equipment (CPEs) over a first set of lines in a binder, where the binder further includes a second set of lines associated with a second set of CPEs serviced by a second distribution point, receiving crosstalk information associated with crosstalk between the first set of CPEs and the second set of CPEs without receiving data sent to or from the second set of CPEs, and using the crosstalk information to reduce crosstalk between the first set of lines and the second set of lines.

A communication device for wireline communication is described. The communication device may include means for providing service by a first distribution point to a first set of consumer premises equipment (CPEs) over a first set of lines in a binder, where the binder further includes a second set of lines associated with a second set of CPEs serviced by a second distribution point, means for receiving crosstalk information associated with crosstalk between the first set of CPEs and the second set of CPEs without receiving data sent to or from the second set of CPEs, and means for using the crosstalk information to reduce crosstalk between the first set of lines and the second set of lines.

Another communication device for wireline communication is described. The communication device may include a processor, memory in electronic communication with the processor, and instructions stored in the memory. The instructions may be operable to cause the processor to provide service by a first distribution point to a first set of consumer premises equipment (CPEs) over a first set of lines in a binder, where the binder further includes a second set of lines associated with a second set of CPEs serviced by a second distribution point, receive crosstalk information associated with crosstalk between the first set of CPEs and the second set of CPEs without receiving data sent to or from the second set of CPEs, and use the crosstalk information to reduce crosstalk between the first set of lines and the second set of lines.

A non-transitory computer readable medium for wireline communication is described. The non-transitory computer-readable medium may include instructions operable to cause a processor to provide service by a first distribution point to a first set of consumer premises equipment (CPEs) over a first set of lines in a binder, where the binder further includes a second set of lines associated with a second set of CPEs serviced by a second distribution point, receive crosstalk information associated with crosstalk between the first set of CPEs and the second set of CPEs without receiving data sent to or from the second set of CPEs, and use the crosstalk information to reduce crosstalk between the first set of lines and the second set of lines.

In some examples of the method, communication devices, and non-transitory computer-readable medium described above, the crosstalk information includes: time synchronization information for synchronizing communications of the first set of CPEs with communications of the second set of CPEs. In some examples of the method, communication devices, and non-transitory computer-readable medium described above, the time synchronization information includes a time of day or a loop timing over a crosstalk channel. Some examples of the method, communication devices, and non-transitory computer-readable medium described above may further include processes, features, means, or instructions for downloading the crosstalk information from a server that may be separate from the second set of CPEs.

In some examples of the method, communication devices, and non-transitory computer-readable medium described above, using the crosstalk information to reduce crosstalk includes: constructing a vectoring matrix using a QR decomposition of a plurality of channel matrices, where the vectoring matrix may be from a group consisting of: a precoding matrix and a canceller matrix. Some examples of the method, communication devices, and non-transitory computer-readable medium described above may further include processes, features, means, or instructions for multiplying the vectoring matrix with a channel matrix, where the channel matrix may be based at least in part on the received crosstalk information.

In some examples of the method, communication devices, and non-transitory computer-readable medium described above, the vectoring matrix includes a block diagonal matrix. In some examples of the method, communication devices, and non-transitory computer-readable medium described above, using the crosstalk information to reduce crosstalk includes: constructing a vectoring matrix using an inverse or pseudoinverse of a plurality of channel matrices, where the vectoring matrix may be from a group consisting of: a precoding matrix and a canceller matrix. Some examples of the method, communication devices, and non-transitory computer-readable medium described above may further include processes, features, means, or instructions for multiplying the vectoring matrix with a channel matrix, where the channel matrix may be based at least in part on the received crosstalk information.

In some examples of the method, communication devices, and non-transitory computer-readable medium described above, the crosstalk information may be from the group consisting of: a downstream channel matrix, a pilot sequence assignment, a quadrant scrambler state, synchronization information associated with the first distribution point and the second distribution point, and a superframe alignment and synchronization symbol index. In some examples of the method, communication devices, and non-transitory computer-readable medium described above, the first set of CPEs may be associated with a first operator and the second set of CPEs may be associated with a second operator.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a block diagram of a digital subscriber line (DSL) system with CPEs communicatively coupled to a CO via a cable bundle in accordance with aspects of the present disclosure;

FIG. 2 illustrates an example of a DSL system including a DSL access multiplexer (DSLAM) that supports vectoring across multiple CO boxes/cards/DSLAMs either owned by the same operator or by different operators in accordance with aspects of the present disclosure;

FIG. 3 illustrates an example of a DSL system that supports vectoring across multiple CO boxes/cards/DSLAMs either owned by the same operator or by different operators in accordance with aspects of the present disclosure;

FIGS. 4 through 5 show a block diagrams of devices that may perform vectoring across multiple CO boxes/cards/DSLAMs either owned by the same operator or by different operators in accordance with aspects of the present disclosure;

FIGS. 6 through 7 illustrate methods for vectoring across multiple CO boxes/cards/DSLAMs either owned by the same operator or by different operators in accordance with various aspects of the present disclosure.

### DETAILED DESCRIPTION

Vectoring between independent distribution points may be achieved without the exchange of tone data and/or matrix coefficients by using a construction of precoder and canceller matrices with a block diagonal structure. That is, different vector groups are decoupled and vectored independently through an appropriate selection of a number of digital subscriber line (DSL) lines to be vectored. A redundant number of lines are used such that a total number of vectored lines at a first distribution point is equal to a set of active lines to consumer premises equipment (CPEs) and a number of vectored lines in the same cable binder associated with a different distribution point. The redundant lines are vectored to cancel crosstalk from the active lines of the first distribution point and the lines associated with the different distribution point.

By using redundant lines, and based at least in part on the construction of precoder matrices, downstream vectoring is achieved without the exchange of tone data between distribution points, and crosstalk information for channel estimation may be exchanged through a separate server, such as a cloud network. Furthermore, upstream vectoring is achieved without the exchange of tone data, and the distribution points coordinate the exchange of information (such as training sequences, synchronization information, etc.) for use in vectoring without a direct connection between the distribution points. Thus, vectoring among the lines of multiple distribution points may be achieved without a direct connection between the distribution points (e.g., the distribution points are not directly connected by a cable, such as when the distribution points are not collocated or when the distribution points are owned by different operators).

Aspects of the disclosure that are introduced above are described below in the context of a DSL system. Aspects of the disclosure are further illustrated by and described with reference to device diagrams, system diagrams, and flowcharts that relate to vectoring across multiple CO boxes/cards/DSLAMs either owned by the same operator or by different operators.

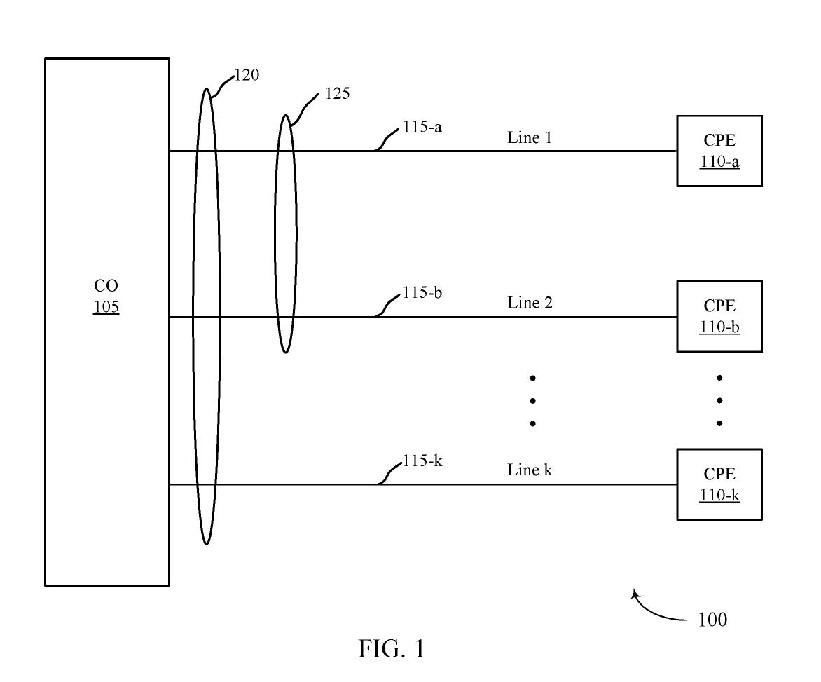

FIG. 1 illustrates an example of a DSL system 100 with CPEs communicatively coupled to a CO via a cable binder in which techniques for vectoring across multiple CO boxes/cards/DSLAMs either owned by the same operator or by different operators are implemented. DSL system 100 includes a CO 105 that is connected to a number of remote nodes, such as CPEs 110 (e.g., CPEs 110-a through 110-k), via a cable binder 120 comprising one or more sub-binders 125. The CPEs 110 are communicatively coupled to the CO 105 via respective subscriber lines denoted 115-a, 115-b, through 115-k. Each of the lines 115-a, 115-b, and 115-k includes one or more twisted-pair copper wire connections. A given CPE 110 includes a modem and other hardware configured to allow the CPE 110 send and receive data to and from CO 105.

Communications between the CO 105 and the CPEs 110 include both downstream and upstream communications for each of the active subscriber lines 115. The downstream direction refers to the direction from CO 105 to CPE 110, and the upstream direction is the direction from CPE 110 to CO 105. Although not explicitly shown in FIG. 1, each of the subscriber lines 115 of DSI system 100 includes a CO transmitter and a CPE receiver for use in communicating in the downstream direction, and a CPE transmitter and a CO receiver for use in communicating in the upstream direction. On both the CO 105 and CPE 110 side, hardware implementing both a transmitter and a receiver is generically referred to as a modem. In some cases, CO 105 may be referred to as a distribution point.

Because different subscriber lines 115 are in close proximity with each other in cable binder 120 and sub-binder 125, these subscriber lines 115 can be susceptible to crosstalk interference. Therefore, data signals transmitted on neighboring or close-proximity subscriber lines 115 can be superimposed on and contaminate each other. Based at least in part on such crosstalk, data signals transmitted over subscriber lines 115 can be considerably degraded by the crosstalk interference generated on one or more adjacent subscriber lines 115 in the same and/or nearby multi-core cable or cable binder 120. Accordingly, a transmission on one subscriber line 115 may be detected on other subscriber lines 115. To help alleviate the issue of transmitting and receiving data on a subscriber line 115 that has been compromised by crosstalk interference, DSL system 100 uses vectoring to decrease the effects of interference that occurs among multiple subscriber lines 115. Vectoring enables coordinated communication between twisted pairs of DSL lines sharing a same cable binder to mitigate crosstalk.

Vectoring removes so-called far end cross talk (FEXT) noise of other DSL subscriber lines (e.g., very-high-bit-rate digital subscriber line 2 (VDSL2) lines) sharing the same cable binder 120. Vectoring is also performed in systems complying with the International Telecommunication Union (ITU) G.fast standard, in addition to other types of wireline communication systems. For example, Japan and Korea use the VDSL2 30a profile for DSL services, where fiber lines are extended closer to subscribers and a bandwidth of 30 MHz is used in communicating by DSL from the fiber line endpoint to the CPE. The ITU G.vector standard provides a description of one implementation of vectoring, but other implementations of vectoring are also possible. A DSLAM may perform vectoring for both downstream and upstream transmissions because a DSLAM alone may service all of the subscriber lines 115 in a cable binder 120. However, if there are multiple DSLAMs serving the same cable binder 120, vectoring may be separately performed across all subscriber lines 115 served by the multiple DSLAMs and involve the exchange of crosstalk matrix coefficients between the DSLAMs. The techniques described below provide for the vectoring across all subscriber lines served by the multiple DSLAMs without exchanging subscriber data between the DSLAMs, thereby preserving the privacy and security of subscriber data serviced by different DSLAMs, which may be associated with different operators.

To accomplish vectoring in this scenario, CO 105 pre-codes signals that are transmitted, and correspondingly decode signals that are received, via a transceiver for every tone (frequency) used by devices in the network. FEXT precoding (pre-compensation) and FEXT cancellation (post-processing or post-coding) may be accomplished using matrix coefficients associated with the pairs of a vectored group, such as vector groups associated with downstream and upstream vectoring.

In an example of downstream vectoring, N represents a number of CO 105 ports (or lines) transmitting in the vectored system, and M represents a number of active CPE 110 modems receiving, where M≦N. A downstream input-output relationship at a given tone k (i.e., all variables in the below equations are in the frequency domain) is represented by the equation

Y(k)=H(k)·X(k)+r(k) (1)

where, Y is the fast Fourier transform (FFT) outputs at one or more CPEs 110 organized as an M×1 vector, H is a channel matrix of dimension M×N, X is the inverse FFT (IFFT) inputs at the CO 105 organized as an N×1 vector, and r is an M×1 downstream receive noise vector.

Additionally, L represents a number of active CO ports, where a pre-coder matrix P(k) has dimension N×L. The IFFT inputs X at a given tone are represented by the equation

X(k)=P(k)·S(k) (2)

where S is an L×1 vector of active CO 105 inputs. Thus, using equation (2), equation (1) takes the form

Y(k)=H(k)·P(k)·S(k)+r(k) (3)

For upstream vectoring, N represents a number of CO 105 ports (lines) receiving in the vectored system, where N may include subscriber lines 115 not connected to an active CPE 110 as well as common mode receive paths (if any) intentionally present in CO 105 by design. Additionally, M may represent a number of active CPE modems transmitting (where M≦N). An upstream input-output relationship at a given tone k is given by the equation

Y(k)=G(k)·X(k)+v(k) (4)

where Y is the FFT outputs at one or more CO organized as an N×1 vector, G is a channel matrix of dimension N×M, X is the IFFT inputs at a CPE 110 organized as an M×1 vector, and v is an N×1 upstream receive noise vector. As mentioned above, L represents the number of active receive CO ports. Additionally, a canceller matrix, C(k), has dimension L×N, and S is an L×1 vector of active CO outputs given by the equation

S(k)=C(k)·Y(k)=C(k)·[G(k)·X(k)+v(k)] (5)

Thus, equations (1) through (5) are used by CO 105 to perform upstream and downstream vectoring for multiple subscriber lines 115. DSLAMs, line cards and/or boxes associated with different COs may operate without a direct connection between them while achieving vectoring for a maximum number of subscriber lines. Precoder and canceller matrices are based at least in part on the tone data within a given DSLAM, where, no tone data is shared amongst different DSLAMs.

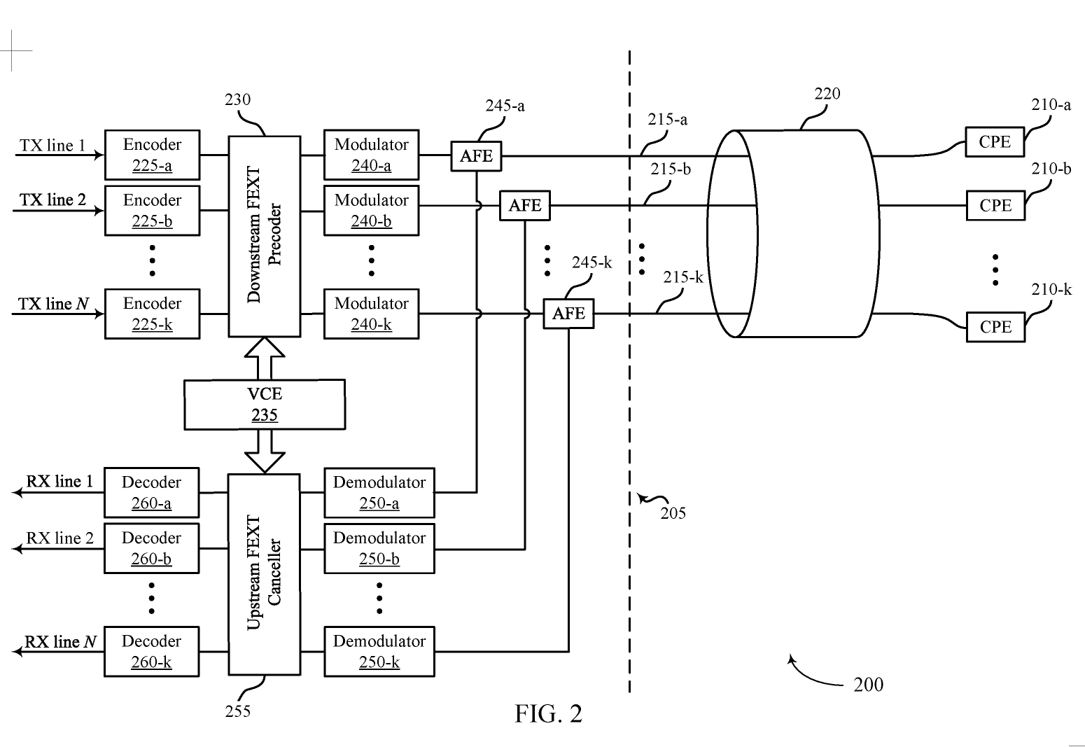

FIG. 2 illustrates an example of a DSL system 200 including a DSLAM 205 that supports vectoring across multiple CO boxes/cards/DSLAMs either owned by the same operator or by different operators. DSLAM 205 may communicate with CPEs 210-a through 210-k over subscriber lines 215-a through 215-k, where the subscriber lines 215 share the same cable binder 220. In some cases, DSLAM 205 may be located at a CO or at a distribution point, such as CO 105 as described with reference to FIG. 1. DSL system 200 may enable vectoring when another independent DSLAM (e.g., a different DSLAM that is not connected to DSLAM 205) (not shown) communicates using the same cable binder 220. The different DSLAMs may be associated with the same or different operators, and the functions described with reference to DSLAM 205 may be similarly completed by a line card or a box associated with a CO. The functions performed by DSLAM 205 may be implemented in a vector canceller that includes an application-specific integrated circuit (ASIC) or in a field programmable gate array (FPGA).

DSLAM 205 performs vectoring for both downstream and upstream communications in DSL system 200. Data symbols intended for one or more CPEs 210 are encoded using at least one encoder 225 (e.g., encoder 225-a through 225-k). Additionally, downstream FEXT precoder 230 precedes the modulation of signals to be transmitted. For example, FEXT precoder 230 performs mathematical operations that enable vectored noise cancellation at CPEs 210. A vectoring control entity (VCE) 235 supplies updated channel matrices and matrix coefficients to FEXT precoder 230, and further controls the FEXT cancellation process, such as indicating from which subscriber lines 215 to cancel FEXT. That is, VCE 235 selects a number of redundant physical or virtual subscriber lines 215 to be used for channel estimation and the construction of a precoder matrix. VCE 235 additionally coordinates the initialization of DSL links and synchronize communication timing by aligning synchronization symbols in DSL system 200.

The FEXT precoder 230 transmits the data symbols to one or more modulators 240, where the data symbols are modulated prior to transmission. For each subscriber line 215, the modulated data symbols are transmitted through an analog front end (AFE) 245 (e.g., AFE 245-a through 245-k), which transmits the data stream as an analog signal on subscriber lines 215.

Multiple synchronized downstream vector groups associated with the same or different operators may be transmitted in the same cable binder 220, where DSLAM 205 transmits one vector group and another DSLAM (not shown) transmits another vector group. DSLAM 205 transmits a vectored signal that eliminates crosstalk from a set of redundant lines, and the signal from the redundant lines further eliminates crosstalk from the lines of the other DSLAM sharing the same cable binder. In an example, a vector group associated with a first DSLAM (downstream vector group 1) is represented by the equation

Y₁(k)=H₁₁(k)·P₁(k)·S₁(k)+H₁₂(k)·P₂(k)·S₂(k)+r₁(k) (6)

Similarly, a vector group associated with a second DSLAM (downstream vector group 2) is represented by the equation

Y₂(k)=H₂₁(k)·P₁(k)·S₁(k)+H₂₂(k)·P₂(k)·S₂(k)+r₂(k) (7)

Combining equations (6) and (7) for the two vector groups results in

Y(k)=H(k)·P(k)·S(k)+r(k) (8)

where, Y(k)=[Y*₁(k)Y*₂(k)]*, S(k)=[S*₁(k)S*₂(k)]*, r(k)=[r*₁(k)r*₂(k)]*,

$$P ( k ) = [ \begin{matrix}{P}_{1} ( k ) & 0 \\ 0 & {P}_{2} ( k )\end{matrix} ] , and H ( k ) = [ \begin{matrix}{H}_{11} ( k ) & {H}_{12} ( k ) \\ {H}_{21} ( k ) & {H}_{22} ( k )\end{matrix} ]$$

(* is the Hermitian transpose of a matrix).

The geometric construction of a precoder matrix allows for multiple vector groups to be decoupled and vectored independently. In an example of precoder matrix construction, in downstream vector group 1 given by equation (6), channel matrix H₁₂(k) has dimension M₁×N₂ and precoder matrix P₂(k) has dimension N₂×L₂. Through the use of redundant downstream lines (whether physical or virtualized lines), M₁<N₂ by construction, where it may be assumed that rank (H₁₂(k))=M₁, and the null space, N(H₁₂(k)), are non-zero. Therefore, through an appropriate choice of N₂, it may be assured that the columns of P₂(k) ∈ N(H₁₂(k)) by construction, leading to the relationship of

H₁₂(k)·P₂(k)=0 (9)

Through a similar analysis of downstream vector group 2 given by equation (7), construction of the columns of P₁(k) results in P₁(k) ∈ N (H₂₁(k)), leading to the relationship

H₂₁(k)·P₁(k)=0 (10)

Based at least in part on relationships (9) and (10), downstream vector group 1 and downstream vector group 2 may be decoupled and vectored independently within the same cable binder 220.

When computing downstream precoder equations, the dimensions of the submatrices H(k) and P(k) are given as:
P₁(k): N₁×L₁; P₂(k): N₂×L₂; H₁₁(k): M₁×N₁; H₁₂(k): M₁×N₂; H₂₁(k): M₂×N₁; H₂₂: M₂×N₂; where N₁≧L₁+M₂≧M₂; N₂≧L₂+M₁≧M₁ and

$$H ( k ) \cdot P ( k ) = [ \begin{matrix}{H}_{11} ( k ) \cdot {P}_{1} ( k ) & {H}_{12} ( k ) \cdot {P}_{2} ( k ) \\ {H}_{21} ( k ) \cdot {P}_{1} ( k ) & {H}_{22} ( k ) \cdot {P}_{2}\end{matrix} ] = [ \begin{matrix}{H}_{11} ( k ) \cdot {P}_{1} ( k ) & 0 \\ 0 & {H}_{22} ( k ) \cdot {P}_{2} ( k )\end{matrix} ]$$

When the number of active ports is equal to the active number of CPEs, then Lᵢ=Mᵢ, with i=1, 2 (e.g., M₁=L₁ and M₂=L₂). Further, Hᵢᵢ(k)·Pᵢ(k)=I_{M}_{ᵢ} where Mᵢ×Mᵢ is the identity matrix, and Nᵢ≧Mᵢ+Mⱼ (e.g., N₁≧M₁+M₂). Additionally or alternatively, there may be a redundant case where the number of active CO ports is greater than the number of active CPEs. That is, Lᵢ>Mᵢ, with i=1, 2, leading to Hᵢᵢ(k)·Pᵢ(k)=[I_{M}_{ᵢ}, 0], which is a rectangular matrix of dimension Mᵢ×Lᵢ.

In a further example of precoder matrix P(k) construction, let H*₁₂(k)=Q₁₂(k). R₁₂(k), which is the QR decomposition of transposed matrix H*₁₂(k), where Q₁₂(k) is a unitary matrix with dimension N₂×N₂, and R₁₂(k) is an upper triangular matrix of dimension N₂×M₁. If Q₁₂(k)=[Q1₁₂(k), Q2₁₂(k)], where Q1₁₂(k) is N₂×M₁, then the columns of Q2₁₂(k) ∈ N(H₁₂(k)). Correspondingly, H*₁₂(k)=Q₁₂(k)·R₁₂(k)=[Q1₁₂(k), Q2₁₂(k)]·[R1*₁₂(k), 0]*, where R1₁₂(k) is an upper triangular matrix with dimension M₁×M₁. Further, Q2*₁₂(k)·H*₁₂(k)=[Q2*₁₂(k)·Q1₁₂(k),I_{M}_{₁}]·[R1*₁₂(k), 0]* and Q2*₂(k)·Q1₁₂(k)=0. Therefore, Q2*₁₂(k)·H₁₂(k)=0, which implies H₁₂(k)·Q2₁₂(k)=0, and the columns of Q2₁₂(k) ∈ N (H₁₂(k)).

One may define P₂(k)=Q2₁₂(k)·[H₂₂(k)·Q2₁₂(k)]⁻¹, and H₁₂(k)·P₂(k)=0 and H₂₂(k)·P₂(k)=I_{M}_{₂}. Further, let H*₂₁(k)=Q₂₁(k)·R₂₁(k) be the QR decomposition of H*₂₁(k), and Q₂₁(k)=Q1₂₁(k),Q2₂₁(k)], where Q1₂₁ has dimension N₁×M₂, and the columns of Q2₂₁(k) ∈ N(H₂₁(k)). Similarly, P₁(k)=Q2₂₁(k)·[H₁₁(k)·Q2₂₁(k)]⁻¹ leads to H₂₁(k)·P₁(k)=0 and H₁₁(k)·P₁(k)=1_{M}_{₁}. Thus, a solution for P(k) may be given as:

$$P ( k ) = [ \begin{matrix}{P}_{1} ( k ) & 0 \\ 0 & {P}_{2} ( k )\end{matrix} ] ,$$

where P₁(k) and P₂(k) are described above.

Another method for deriving a zero-forcing precoder matrix for downstream vectoring, such as in a case of minimum redundancy (i.e., N₁=M1+M2 and N₂=M_{1+M}₂), is described. For a first distribution point/DSLAM/CO, a channel matrix H*₁(k) is defined as

$${H}_{* 1} ( k ) = [ \begin{matrix}{H}_{11} ( k ) \\ {H}_{21} ( k )\end{matrix} ] .$$

Since H₁₁(k) is an M₁×N₁ matrix and H₂₁(k) is an M₂×N₁ matrix, H*₁(k) is an (M₁+M₂)×N₁ matrix. In the case of N₁=M₁+M₂, H*₁(k) is a nonsingular matrix (i.e., H*₁(k) is a square and invertible matrix).

P*₁(k)=[H*₁(k)]⁻¹ is defined to be the inverse of the channel matrix H*₁(k). Then the first M₁ columns of the N₁×(M₁+M₂) matrix P*₁(k) forms the precoder P₁(k), such that P*₁(k)=[P₁(k) P₁′(k)], where P₁(k) is N₁×M₁ and P₁′(k) is N₁×M₂, thus

$${H}_{* 1} ( k ) {P}_{1} ( k ) = [ \begin{matrix}{H}_{11} ( k ) {P}_{1} ( k ) \\ {H}_{21} ( k ) {P}_{1} ( k )\end{matrix} ] = [ \begin{matrix}{I}_{M 1} ( k ) \\ {0}_{M 2 \times M 1} ( k )\end{matrix} ]$$

Similarly, for the second distribution point/DSLAM/CO, a channel matrix, H*₂(k), is defined as

$${H}_{* 2} ( k ) = [ \begin{matrix}{H}_{22} ( k ) \\ {H}_{12} ( k )\end{matrix} ] .$$

Since H₂₂(k) is an M₂×N₂ matrix and H₁₂(k) is an M₁×N₂ matrix, H*₂(k) is a (M₁+M₂)×N₂ matrix. In case of N₂=M₁+M₂, H*₂(k) is a nonsingular matrix (i.e., H*₂(k) is a square and invertible matrix).

P*₂(k)=[H*₂(k)]⁻¹ is defined to be the inverse of the channel matrix H*₂(k). Then the first M₂ columns of the N₂×(M₁+M₂) matrix P*₂(k) forms the precoder P₂(k), such that P*₂(k)=[P₂(k) P₂′(k)], where P₂(k) is N₂×M₂ matrix and P₂′(k) is N₂×M₁ matrix.

$${H}_{* 2} ( k ) {P}_{2} ( k ) = [ \begin{matrix}{H}_{22} ( k ) {P}_{2} ( k ) \\ {H}_{12} ( k ) {P}_{2} ( k )\end{matrix} ] = [ \begin{matrix}{I}_{M 2} ( k ) \\ {0}_{M 1 \times M 2} ( k )\end{matrix} ]$$

In another case, if N₁≧M₁+M₂ or N₂≧M₁+M₂, a right pseudoinverse of H*₁(k) and H*₂(k) may be used (instead of an inverse) to define the precoders P₁(k) and P₂(k). The right pseudoinverse of a matrix A is defined as A⁻=A*(AA*)^{31 1}.

Downstream vectoring with coordination between different DSLAMs for coefficient exchange is achieved without a direct connection between the DSLAMs and without the exchange of tone data. For example, in channel matrix H(k) estimation, the matrix formed by the elements of Hᵢⱼ(k) (where i=1, 2 and j=1, 2) is estimated using test signals. In the case of coefficient exchange for precoder matrix calculation, H₂₁(k) may be used at a first DSLAM in downstream vector group 1 for computing P₁. Similarly, H₁₂(k) may be used by the second DSLAM in downstream vector group 2 for computing P₂. Therefore, there may be coordination between the DSLAMs for this channel matrix estimation and coefficient exchange process. In one example, this coordination is achieved through a cloud network.

No tone data is exchanged between multiple DSLAMs to perform downstream precoding and vectoring is achieved through redundancy, where the number of redundant lines used by the DSLAM is be equal to the number of active lines used by another DSLAM sharing the same cable binder 220. For instance, when a first DSLAM uses 16 lines and a second DSLAM uses 8 lines, the number of redundant lines activated (e.g., virtualized) by the first DSLAM is equal to 8 and the second DSLAM activates 16 redundant lines. In other examples, the number of redundant lines may be at least twice the number of vectored lines. However, as no tone data is exchanged, a direct connection between the multiple DSLAMs is avoided. In some cases, the number of active CO ports is equal to the number of active CPEs served by a DSLAM when computing precoder and canceller equations.

Upstream transmissions from CPEs 210 are received at DSLAM 205 at one or more AFEs 245, and data symbols are demodulated at one or more demodulators 250. An upstream FEXT canceller 255 follow the demodulation of the received signals, where upstream FEXT canceller 255 receives updated channel matrices and matrix coefficients from VCE 235 to cancel crosstalk on the received data symbols. Upstream FEXT canceller 255 then passes the data to one or more decoders 260.

In upstream vectoring with multiple DSLAMs sharing the same cable binder 220, multiple synchronized independent vector groups are formed. For example, a first DSLAM may receive an upstream vector group (upstream vector group 1) represented by the equation

S₁(k)=C₁(k)·G₁₁(k)·X₁(k)+C₁(k)·G₁₂(k)·X₂(k)+C₁(k)·v₁(k) (11)

An upstream vector group received by a second DSLAM (upstream vector group 2) is given by the equation

S₂(k)=C₂(k)·G₂₁(k)·X₁(k)+C₂(k)·G₂₂(k)·X₂(k)+C₂(k)·v₂(k) (12)

Combining these equations for the two upstream vector groups (equations (11) and (12)) and pre-multiplying by the canceller matrix C(k) results in

S(k)=C(k)·Y(k)=C(k)·G(k)·X(k)+C(k)·v(k) (13)

where, Y(k)=[Y*₁(k)Y*₂(k)]*, X(k)=[X*₁(k)X*₂(k)]*, v(k)=[v*₁(k)v*₂(k)]*,

$$G ( k ) = [ \begin{matrix}{G}_{11} ( k ) & {G}_{12} ( k ) \\ {G}_{21} ( k ) & {G}_{22} ( k )\end{matrix} ] , and C ( k ) = [ \begin{matrix}{C}_{1} ( k ) & 0 \\ 0 & {C}_{2} ( k )\end{matrix} ] .$$

The geometric construction of canceller matrix C(k) may allow for multiple vector groups to be decoupled and vectored independently. For example, in the construction of canceller matrices with two DLSAMs sharing the same cable bundle, in upstream vector group 1 given by equation (11), G₁₂(k) has dimension N₁×M₂ and C₁(k) has dimension L₁×N₁. Through the use of redundant lines, M₂<N₁ by construction, where it may be assumed rank (G₁₂(k))=M₂. Thus, the null space, N(G₁₂(k)), is non-zero. Through an appropriate choice of N₁, the columns of C₁(k) ∈ N(G*₁₂(k)) by construction, leading to

C₁(k)·G₁₂(k)=0 (14)

Similarly, for upstream vector group 2 given by equation (12), a similar construction of the columns of C₂(k) ∈ N (G*₂₁(k)) may lead to

C₂(k)·G₂₁(k)=0 (15)

Through (14) and (15), upstream vector group 1 and upstream vector group 2 may be decoupled and therefore vectored independently, enabling vectoring for two DSLAMs that are not connected but share the same cable binder.

For upstream canceller matrix computation equations, dimensions of submatrices of G(k) and C(k) are given as:
C₁(k): L₁×N₁; C₂(k): L₂×N₂; G₁₁(k): N₁×M₁; G₁₂(k): N₁×M₂; G₂₁(k): N₂×M₁; G₂₂: N₂×M₂; where N₁≧L₁+M₂≧M₂; N₂≧L₂+M₁≧M₁ and

$$C ( k ) \cdot G ( k ) = [ \begin{matrix}{C}_{1} ( k ) \cdot {G}_{11} ( k ) & {C}_{1} ( k ) \cdot {G}_{12} ( k ) \\ {C}_{2} ( k ) \cdot {G}_{21} ( k ) & {C}_{2} ( k ) \cdot {G}_{22} ( k )\end{matrix} ] = [ \begin{matrix}{C}_{1} ( k ) \cdot {G}_{11} ( k ) & 0 \\ 0 & {C}_{2} ( k ) \cdot {G}_{22} ( k )\end{matrix} ] .$$

The active number of CO ports may be equal to the number of active CPEs, where Lᵢ=Mᵢ(i=1, 2). Further, Cᵢ(k)·Gᵢᵢ(k)=I_{M}_{ᵢ}=I_{L}_{ᵢ} where Lᵢ×Lᵢ is the identity matrix and Nᵢ≧L₁+L₂. As in the case of downstream vectoring, there may be a redundant case where the number of active CO ports is greater than the number of active CPEs in upstream vectoring. That is, Lᵢ>Mᵢ, and i=1, 2. This may lead to Cᵢ(k)·Gᵢᵢ(k)=[I_{M}_{ᵢ}, 0]*, which may be a rectangular matrix of dimension Lᵢ×Mᵢ.

In an example of the construction of canceller matrix C(k), let G₁₂(k)=Q₁₂(k)·R₁₂(k), be the QR decomposition of G₁₂(k), where Q₁₂(k) is a unitary matrix with dimension N₁×N₁, and R₁₂(k)is an upper triangular matrix of dimension N₁×M₂. If Q₁₂(k)=[(Q1₁₂(k), Q2₁₂(k)], where Q1₁₂(k) has dimensions N₁×M₂, then the columns of Q2₁₂(k) ∈ Null space N (G*₁₂(k)). Correspondingly, G₁₂(k)=Q₁₂(k)·R₁₂(k)=[Q 1₁₂(k), Q2₁₂(k)]·[R1*₁₂(k), 0]*, where R1₁₂(k) is an upper triangular matrix with dimension M₂×M₂. Further, Q2*₁₂(k)·G₁₂(k)=[Q2*₁₂(k)·Q1₁₂(k), I_{M}_{_{1]·[R}}1*₁₂(k), 0]* and Q2*₁₂(k)·Q1₁₂(k)=0. As a result, Q2*₁₂(k)·G₁₂(k)=0, which implies G*₁₂(k). Q2₁₂(k)=0, and the columns of Q2₁₂(k) ∈ N(G*₁₂(k)).

For the construction of the canceller matrix C(k), one may define C₁(k)=[Q*2₁₂(k)·G₁₁(k)]⁻¹·Q*2₁₂(k). Then, C₁(k)·G₁₂(k)=0 and C₁(k)·G₁₁(k)=I_{M}_{₁}. Further, it may be defined that G₂₁(k)=Q₂₁(k)·R₂₁(k)=[Q1₂₁(k), Q2₂₁(k)]·[R*1₂ₗ (k), −]*, where R1₂₁(k) is an upper triangular matrix of dimension M₁×M₁. Similarly, C₂(k)=[Q*2₂₁(k)·G₂₂(k)]⁻¹·Q2*₂₁(k) leads to C₂(k)·G₂₁(k)=0 and C₂(k)·G₂₂(k)=I_{M}_{₂}. Thus, a solution for C(k) may be given as:

$$C ( k ) = [ \begin{matrix}{C}_{1} ( k ) & 0 \\ 0 & {C}_{2} ( k )\end{matrix} ] ,$$

where C₁(k) and C₂(k) are described above.

Another method for deriving a zero-forcing canceller matrix for upstream vectoring, such as in a case of minimum redundancy (i.e., N₁=M1+M2 and N₂=M₁+M₂), is described. For the first distribution point/DSLAM/CO a channel matrix G*₁(k) is defined as G*₁(k)=[G₁₁(k) G₁₂(k)]. Since G₁₁(k) is an N₁×M₁ matrix and G₁₂(k) is an N₁×M₂ matrix, G*₁(k) is an N₁×(M₁+M₂) matrix. In case of N₁=M₁+M₂, G*₁(k) is a nonsingular matrix (i.e., G*₁(k) a square and invertible matrix).

C*₁(k)=[G*₁(k)]⁻¹ is defined to be the inverse of the channel matrix G*₁(k). Then the first M₁ rows of the (M₁+M₂)×N₁ matrix C*₁(k) forms the canceller C₁(k), such that

$${C}_{1 *} ( k ) = [ \begin{matrix}{C}_{1} ( k ) \\ {C}_{1}^{′} ( k )\end{matrix} ] ,$$

where C₁(k) is M₁×N₁, C₁′(k) M₂×N₁, and

C₁(k)G*₁(k)=[C₁(k)G₁₁(k) C₁(k)G₁₂(k)]=[I_{M1}(k) 0_{M1×M2}(k)]

Similarly, for the second distribution point/DSLAM/CO, a channel matrix G*₂(k) is defined as G*₂(k)=[G₂₂(k) G₂₁(k)]. Since G₂₂(k) is an N₂×M₂ matrix and G₂₁(k) is an N₂×M₁ matrix, G*₂(k) is an N₂×(M₁+M₂) matrix. In case of N₂=M₁+M₂, G*₂(k) is a nonsingular matrix (i.e., G*₂(k) a square and invertible matrix).

C*₂(k)=[G*₂(k)]⁻¹ is defined to be the inverse of the channel matrix G*₂(k). Then the first M₂ rows of the (M₁+M₂)×N₂ size matrix C*₂(k) forms the canceller C₂(k), such that

$${C}_{2 *} ( k ) = [ \begin{matrix}{C}_{2} ( k ) \\ {C}_{2}^{′} ( k )\end{matrix} ] ,$$

where C₂(k) is M₂×N₂ and C₂′(k) M₂×N₂

C₂(k)G*₂(k)=[C₂(k)G₂₂(k) C₂(k)G₂₁(k)]=[I_{M2}(k) 0_{M2×M1}(k)]

In another case, if N₂≧M₁+M₂ or N₂≧M₁+M₂, a left pseudoinverse of G*₁(k) and G*₂(k) may be used (instead of the inverse) to define C₁(k) and C₂(k). The left pseudoinverse of a matrix A is defined as A⁺=(A*A)⁻¹A*.

Therefore, to enable the efficient vectoring in the presence of multiple DSLAMs sharing the same cable binder 220, the structure of a precoder matrix P(k) and a canceller matrix C(k) is given as

$$P ( k ) = [ \begin{matrix}{P}_{11} ( k ) & {P}_{12} ( k ) \\ {P}_{21} ( k ) & {P}_{22} ( k )\end{matrix} ] , C ( k ) = [ \begin{matrix}{C}_{11} ( k ) & {C}_{12} ( k ) \\ {C}_{21} ( k ) & {C}_{22} ( k )\end{matrix} ]$$

where P (k) and C(k) have nonzero diagonal elements.
When, N₁>M₁+M₂ and N₂>M₁+M₂, then the use of an inverse (or pseudoinverse) of a channel matrix may not apply, and QR decomposition is used as described herein. For example, a DSLAM may be provisioned with precoder and canceller matrices capable of vectoring all ports in the DSLAM. A first DSLAM and second DSLAM are both capable of handling 48 ports each, and the first and second DSLAMs share the same cable binder. However, when a new service starts, neither the first or second DSLAM have more than a few CPEs turned on, and over time the number of CPEs the DSLAMs serve will increase. In one example, the first DSLAM is serving 16 CPEs and the second CPE is serving 8 CPEs (M₁=16,M₂=8) with a total of 24 subscriber lines. Accordingly, the first DSLAM will use a minimum of 8 redundant lines and the second DSLAM will use a minimum of 16 redundant lines to achieve vectoring as described herein.

However, given that the precoder and canceller matrices are capable of vectoring a certain number of subscriber lines in total (e.g., 48 lines), the hardware used for vectoring could benefit in using more redundant lines, e.g., for robustness (less ill-conditioning), in the calculation of precoder matrices P₁ and P_{2.} In such cases, the first DSLAM and the second DSLAM use a full compute capacity available for vectoring. Thus, the first DSLAM uses 32 redundant lines and the second DSLAM uses 40 redundant lines, as in the case where N₁>M₁+M₂ and N₂>M₁+M₂, and a QR decomposition is used.

In a further example, over time, both the first DSLAM and the second DSLAM end up serving 24 CPEs each. Therefore, a full vectoring capacity will be used, and the number of redundant lines for each DSLAM will be 24. As a result, N₁=M₁+M₂=N₂ and a derivation of precoder and canceller matrices from the inverse of pseudoinverse of channel matrices is used.

Upstream vectoring is thus achieved with no tone data and no coefficient exchange between multiple DSLAMs. In an example of channel matrix G(k) estimation, the matrix formed by the elements of Gᵢⱼ(k) (where i=1, 2;j=1, 2) is estimated using test signals. In the case of coefficient exchange for a precoder matrix calculation, G₁₂(k) may be used at the first DSLAM in upstream vector group 1 for computing C₁, and G₂₁(k) may be used by the second DSLAM in upstream vector group 2 for computing C₂. Therefore, there may be coordination between multiple DSLAMs for this channel matrix estimation and coefficient exchange process, where coordination may be achieved through, for example, a cloud network. This may be achieved at the cost of redundancy, as the number of lines used by the CO may be at least twice the number of vectored lines. However, as no tone data or coefficients may be exchanged, there is no direct connection between the multiple DSLAMs.

Thus DSL system 200 supports vectoring of two independent vector groups while sharing the same copper cable binder running on two or more different DSLAMs owned by different operators. Some of the examples provided herein are described with reference to two DSLAMs and two corresponding vector groups. However, it is understood that these descriptions may apply to two or more DSLAMs and two or more vector groups. In some example, these techniques may be used even if the DSLAMs are owned and/or operated by the same operator. For example, two distribution points owned by the same operator may share the same cable binder 220 but be physically too far apart to be connected.

Vectoring can be achieved with no coefficient exchange (or limited coefficient exchange via a cloud network, as in the case of downstream precoding) and without sharing tone data. Accordingly, coordinated vectoring may not require any direct high speed hardware connection for exchange of data or coefficients and a DSLAM's hardware can be used as is. Additionally, there may be no need for additional computational resources for implementing downstream precoding and upstream cancelling. Thus, multiple distribution points can operate independently while still achieving vectoring.

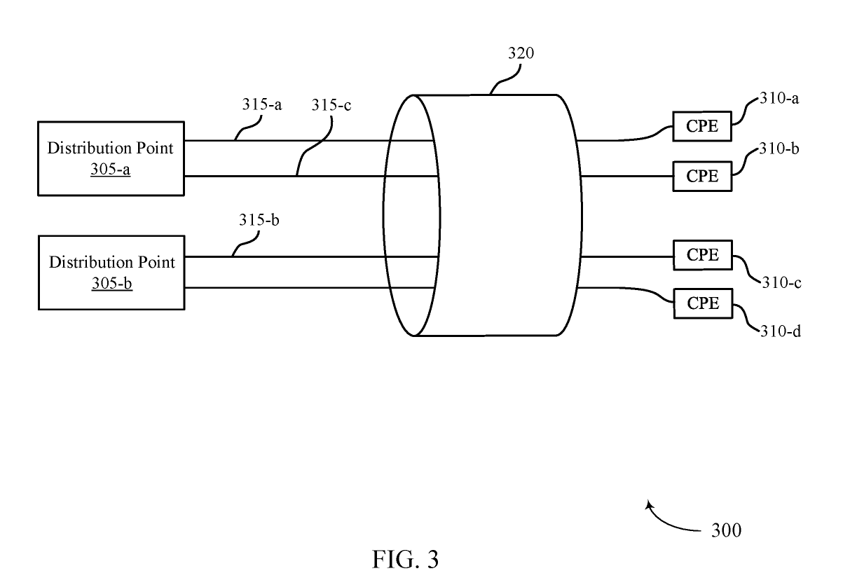

FIG. 3 illustrates an example of a DSL system 300 that supports vectoring across multiple CO boxes/cards/DSLAMs either owned by the same operator or by different operators. DSL system 300 includes first distribution point 305-a and second distribution point 305-b, which are each examples of a CO 105 described with reference to FIG. 1. The first distribution point 305-a is associated with a first group of CPEs, including CPE 310-a and CPE 310-b. Similarly, distribution point 305-b is associated with a second group of CPEs including CPE 310-c and CPE 310-d. The distribution points 305 communicate with the CPEs 310 over subscriber lines 315 and share the same cable binder 320. DSL system 300 illustrates an example of the selection of physical or virtual redundant lines to enable vectoring between multiple distribution points that are not connected.

To transmit a vectored signal while sharing the same cable binder, the distribution points 305 selects a redundant number of lines for use in the construction of precoding and canceller matrices, as described with reference to FIG. 2. For example, the first distribution point 305-a transmits a signal over subscriber line 315-a while distribution point transmits a signal over subscriber line 315-b. To enable vectoring over its subscriber lines 315-a, first distribution point 305-a activates a number of physical or virtual redundant lines 315-c equal to a number of subscriber lines 315-b used by the second distribution point 305-b.

The first distribution point 305-a uses the redundant lines 315-b to transmit a vectored signal to CPE 310-a such that subscriber line 315-a is free from crosstalk. For example, first distribution point 305-a transmits a vectored signal over subscriber lines 315-a that is not affected by crosstalk from redundant lines 315-c. Additionally, the signal transmitted over redundant lines 315-c enables the cancellation of crosstalk from subscriber line 315-b. The second distribution point 305-b similarly selects redundant lines to cancel crosstalk on the signal transmitted by first distribution point 305-a.

In some examples, distribution point 305-a and distribution point 305-b have synchronous operation. That is, distribution point 305-a and distribution point 305-b are synchronized either via a time of day (TOD) protocol (e.g., CPEs associated with each distribution point 305 are configured to transmit at a certain time) or some other mechanism (e.g., loop timing over a crosstalk channel including a CPE-like timing recovery circuit or mechanism). Accordingly, signals from the first distribution point 305-a and second distribution point 305-b are transmitted over subscriber lines 315 at the same time. Additionally, the CPEs 310 associated with each distribution point 305 may be configured such that signals transmitted by the separate CPEs 310 are received at each distribution point at the same time. In some examples a CPE 310 uses a timing advance to ensure synchronization.

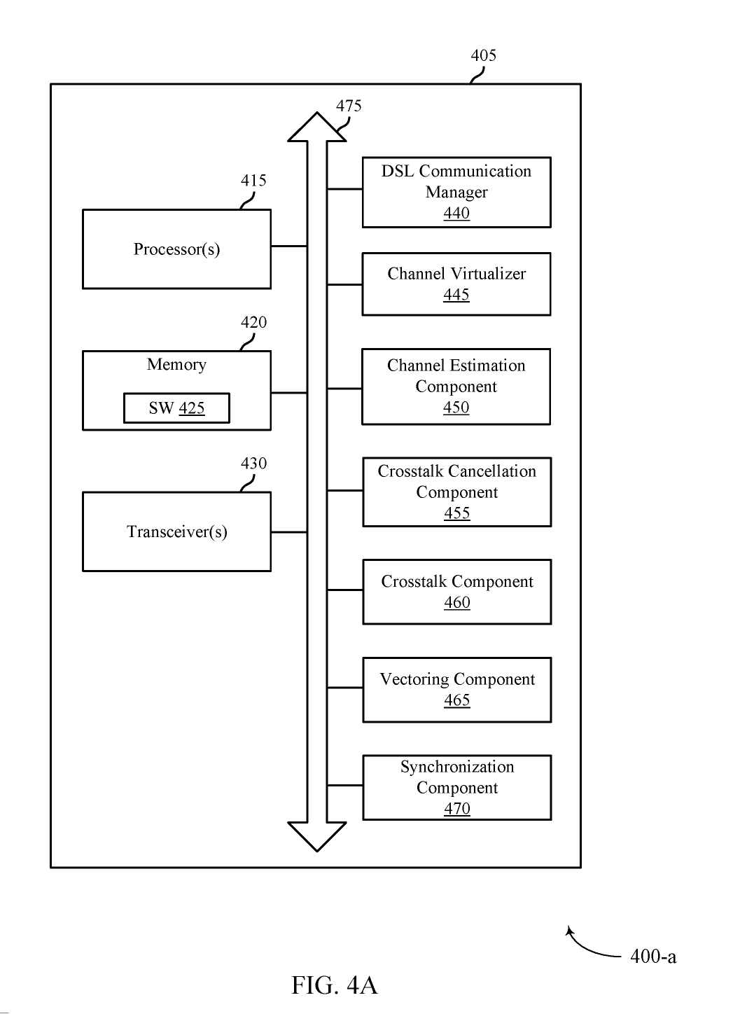

FIG. 4A shows a block diagram 400-a of an example of a communication device 405 that may implement vectoring across multiple CO boxes/cards/DSLAMs either owned by the same operator or by different operators in accordance with various aspects of the present disclosure. The communication device 405 may be an example of a CO 105, a DSLAM 205, or a distribution point 305 described with reference to FIGS. 1 through 3. The communication device 405 includes at least one processor 415, a memory 420, one or more transceivers 430, a DSL communication manager 440, a channel virtualizer 445, a channel estimation component 450, a crosstalk cancellation component 455, a crosstalk component 460, a vectoring component 465, and a synchronization component 470. The processor(s) 415, the memory 420, the transceiver(s) 430, the crosstalk cancellation component 455, the crosstalk component 460, the channel estimation component 450, the vectoring component 465, and the synchronization component 470 are communicatively coupled with a bus 475, which enables communication between these components.

The processor(s) 415 is an intelligent hardware device, such as a central processing unit (CPU), a microcontroller, an application-specific integrated circuit (ASIC), etc. The memory 420 stores computer-readable, computer-executable software (SW) code 425 containing instructions that, when executed, cause the processor(s) 415 or another one of the components of the communication device 405 to perform various functions described herein, for example, to obtain reference vectoring coefficients, determine other vectoring coefficients using a weighted average of multiple estimates obtained using the reference vectoring coefficients, and perform vectoring to reduce crosstalk.

Memory 420 may include random access memory (RAM) and read only memory (ROM). The memory 420 may store computer-readable, computer-executable software code 425 including instructions that, when executed, cause the processor to perform various functions described herein. In some cases, the memory 420 may contain, among other things, a Basic Input-Output system (BIOS) which may control basic hardware and/or software operation such as the interaction with peripheral components or devices.

Computer-executable software code 425 may include code to implement aspects of the present disclosure, including code to support vectoring across multiple CO boxes/cards/DSLAMs either owned by the same operator or by different operators. Computer-executable software code 425 may be stored in a non-transitory computer-readable medium such as system memory or other memory. In some cases, the computer-executable software code 425 may not be directly executable by the processor but may cause a computer (e.g., when compiled and executed) to perform functions described herein.

DSL communication manager 440 may provide service by a first distribution point to a first set of CPEs over a first set of lines in a binder, where the binder further includes a second set of lines associated with a second set of CPEs serviced by a second distribution point. Channel virtualizer 445 may virtualize a third set of lines at the first distribution point corresponding to the second set of CPEs and channel estimation component 450 may obtain a channel estimation for each CPE of the first set of CPEs and the second set of CPEs using the first set of lines and the third set of lines.

Crosstalk cancellation component 455 may compensate transmissions over the first set of lines based at least in part on the channel estimation to cancel crosstalk between the first set of lines and the third set of lines and use the channel estimation to zero crosstalk from lines servicing each CPE from the second set of CPEs. In some cases, using the channel estimation to zero the crosstalk is based at least in part on receiving crosstalk information associated with crosstalk between the first set of CPEs and the second set of CPEs. Using the channel estimation to zero the crosstalk includes constructing a vectoring matrix based at least in part on the virtualized lines, where the vectoring matrix includes a member of a group consisting of: a precoding matrix and a canceller matrix.

Crosstalk component 460 may receive crosstalk information associated with crosstalk between the first set of CPEs and the second set of CPEs without receiving data sent to or from the second set of CPEs and download the crosstalk information from a server that is separate from the second group of CPEs, and the crosstalk information includes a downstream channel matrix, a pilot sequence assignment, a quadrant scrambler state (used in reset mode), synchronization information associated with the first and second distribution points, and a superframe alignment and synchronization symbol index.

Vectoring component 465 may multiply the vectoring matrix with a channel matrix, where the channel matrix is based at least in part on the received crosstalk information. In some cases, the vectoring matrix is a block diagonal matrix. In some cases, using the crosstalk information to cancel crosstalk includes: constructing a vectoring matrix using a QR decomposition of a set of channel matrices or using an inverse or pseudoinverse of a set of channel matrices.

Synchronization component 470 may receive crosstalk information that includes time synchronization information for synchronizing communications of the first group of CPEs with communications of the second group of CPEs. That is, communications of the first group of CPEs are time synchronized with communications of the second group of CPE. In some cases, the time synchronization information includes a time of day or a loop timing over a crosstalk channel.

Again, FIG. 4A shows only one possible implementation of a device executing the features described herein. While the components of FIG. 4A are shown as discrete hardware blocks (e.g., ASICs, FPGAs, semi-custom integrated circuits, etc.) for purposes of clarity, it will be understood that each of the components may also be implemented by multiple hardware blocks adapted to execute some or all of the applicable features in hardware. Alternatively, features of two or more of the components of FIG. 4A may be implemented by a single, consolidated hardware block. For example, a single transceiver 430 chip or the like may implement the processor 415, the DSL communication manager 440, the channel virtualizer 445, the channel estimation component 450, the crosstalk cancellation component 455, the crosstalk component 460, the vectoring component 465, and the synchronization component 470.

In still other examples, the features of each component may be implemented, in whole or in part, with instructions embodied in a memory, formatted to be executed by one or more general or application-specific processors. For example, FIG. 4B shows a block diagram 400-b of another example of a communication device 405-a in which the features of the DSL communication manager 440, the channel virtualizer 445, the channel estimation component 450, the crosstalk cancellation component 455, the crosstalk component 460, the vectoring component 465, and the synchronization component 470 are implemented as computer-readable code stored in memory 420-a and executed by one or more processors 415-a. Other combinations of hardware/software may be used to perform the features of one or more of the components of FIGS. 4A and 4B.

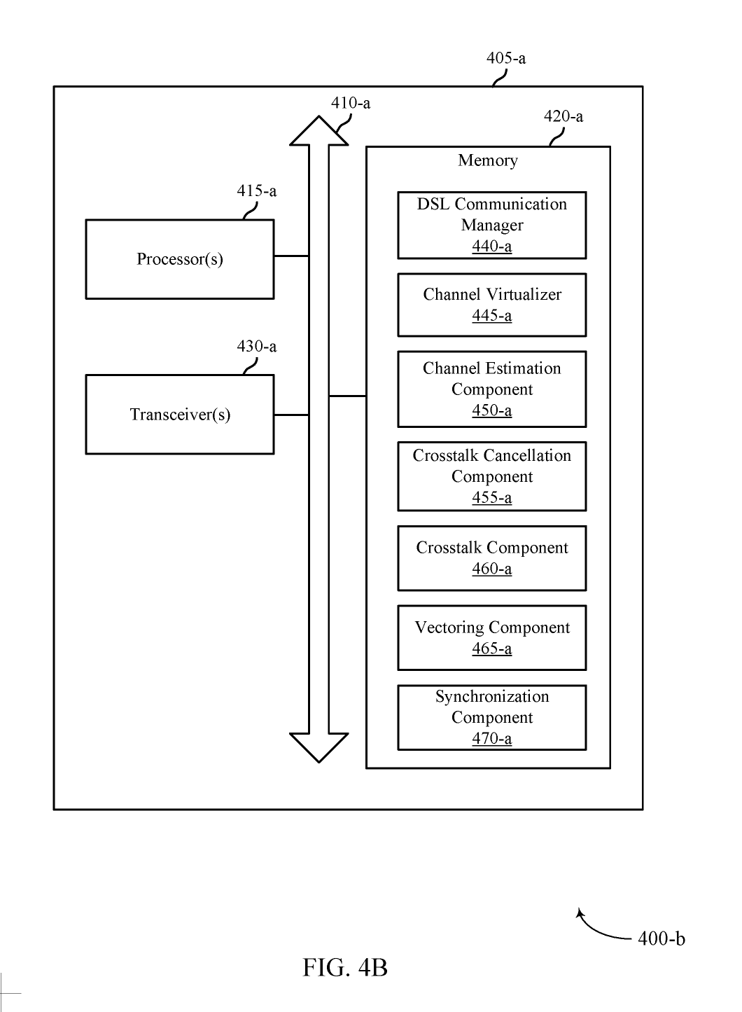

FIG. 5 shows a flowchart illustrating a method 500 for vectoring across multiple CO boxes/cards/DSLAMs either owned by the same operator or by different operators in accordance with various aspects of the present disclosure. The operations of method 500 may be implemented by a communication device 405 or its components as described herein. For example, the operations of method 500 may be performed by a DSLAM 205 or a distribution point 305 as described with reference to FIGS. 2 and 3. In some examples, a communication device 405 may execute a set of codes to control the functional elements of the device to perform the functions described below. Additionally or alternatively, the communication device 405 may perform aspects the functions described below using special-purpose hardware.

At block 505, the DSL communication manager 440 provides service from a first distribution point to a first set of CPEs over a first set of lines in a binder, where the binder further includes a second set of lines associated with a second set of CPEs serviced by a second distribution point. The first distribution point may be associated with a first operator and the second distribution point may be associated with a second operator, and there may be no direct connection between the two distribution points. Alternatively, the distribution points are associated with the same operator, but physically too far apart to be directly connected.

At block 510, the channel virtualizer 445 virtualizes a third set of lines at the first distribution point corresponding to the second set of CPEs. The virtualized lines are used as redundant lines for use in vectoring, as described above, and the number of redundant lines are equal to a number of vectored lines used by the second distribution point. At block 515, channel estimation component 450 uses the virtualized lines to obtain a channel estimation for each CPE of the first set of CPEs and the second set of CPEs using the first set of lines and the third set of lines.

At block 520, the crosstalk cancellation component 460 receives information related to crosstalk between the first set of CPEs and the second set of CPEs, and at block 525, the vectoring component 465 constructs a vectoring matrix based at least in part on the virtualized lines, where the vectoring matrix is a precoding matrix or a canceller matrix.

At block 530, the crosstalk cancellation component 455 uses the channel estimation to compensate transmissions over the first set of lines to cancel crosstalk between the first set of lines and the third set of lines, and at block 535, the crosstalk cancellation component 460 uses the channel estimation to zero crosstalk from lines servicing each CPE from the second set of CPEs.

It is to be appreciated that, in some cases, different vectored signals are generated for different victim-disturber pairs and set of tones. As such, the method 500 shown in FIG. 5 is for the sake of simplicity and illustration, and is not intended to be exhaustive of permutations that can be envisioned for practical implementations of DSL vectoring.

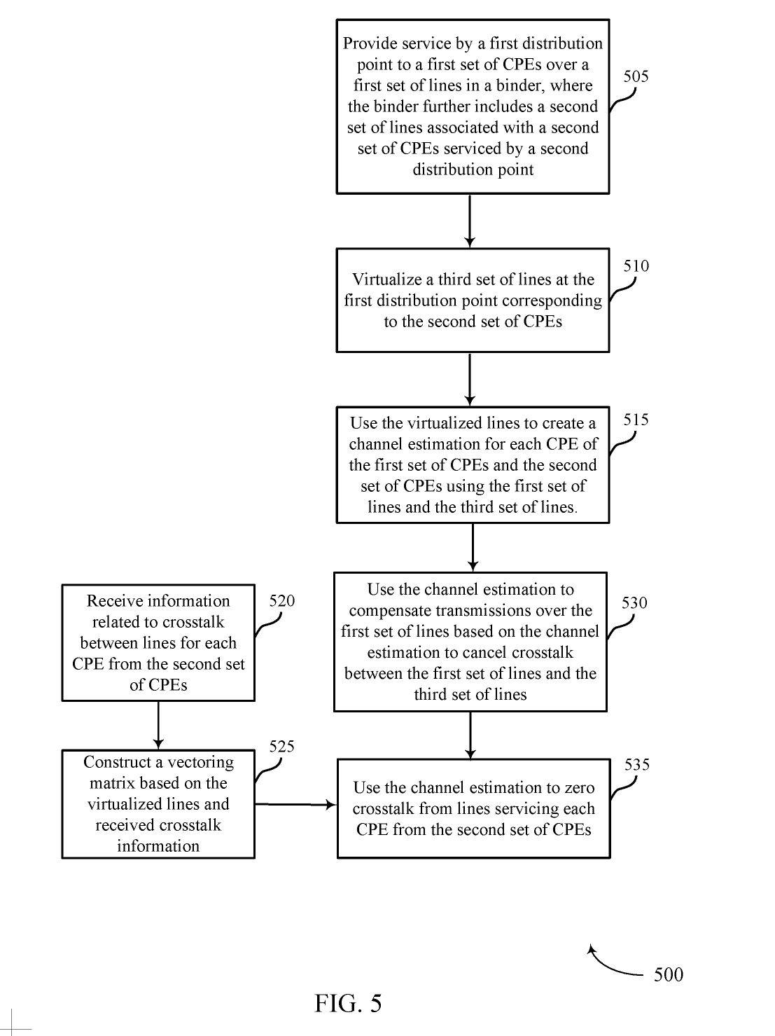

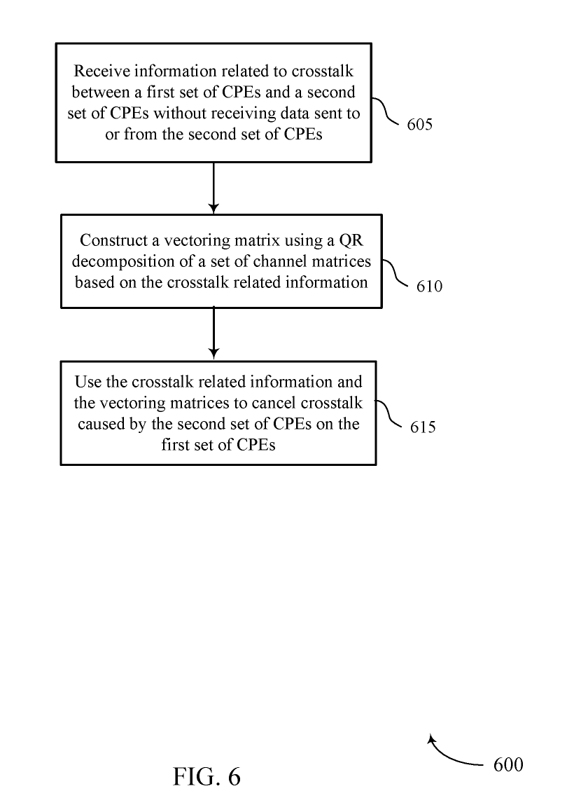

FIG. 6 shows a flow chart that illustrates an example of a method 600 of vectoring across multiple CO boxes/cards/DSLAMs either owned by the same operator or by different operators in accordance with various aspects of the present disclosure. The method 600 may be performed by any of the devices discussed in the present disclosure, but for clarity the method 600 will be described from the perspective of communication device 405 of FIG. 4A. It is to be understood that the method 600 is just one example of techniques of improving vectoring in a DSL system when multiple distribution points share the same cable binder, and the operations of the method 600 may be rearranged, performed by other devices and component thereof, and/or otherwise modified such that other implementations are possible.

At block 605, the crosstalk component 455 receives crosstalk information between a first set of CPEs and a set group of CPEs without receiving transmission data sent to or from the second set of CPEs. At block 610, the vectoring component 465 constructs a vectoring matrix using a QR decomposition or an inverse of a set of channel matrices based at least in part on the crosstalk information. In one example, the crosstalk information includes a downstream channel matrix, a pilot sequence assignment, a quadrant scrambler state, synchronization information associated with the first and second distribution points, and a superframe alignment and synchronization symbol index. A vectoring matrix is constructed through a QR decomposition of the channel matrix, and the vectoring matrix has a block diagonal structure. In some examples, a vectoring matrix is constructed using an inverse, or a pseudoinverse (i.e., a left or right pseudoinverse) of a channel matrix. At block 615, the crosstalk cancellation component 460 uses the vectoring matrix and the crosstalk information to cancel crosstalk caused by the second group of CPEs on the first group of CPEs.

It is to be appreciated that, in some cases, different vectored signals are received for different victim-disturber pairs and set of tones. As such, the method 600 shown in FIG. 6 is for the sake of simplicity and illustration, and is not intended to be exhaustive of permutations that can be envisioned for practical implementations of DSL vectoring.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these.

Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media. The previous description of the disclosure is provided to enable a person skilled in the art to make or use the disclosure.

Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for wireline communication, comprising:
providing service by a first distribution point to a first set of consumer premises equipment (CPEs) over a first set of lines in a binder, wherein the binder further comprises a second set of lines associated with a second set of CPEs serviced by a second distribution point;
virtualizing a third set of lines at the first distribution point corresponding to the second set of CPEs;
obtaining a channel estimation for each CPE of the first set of CPEs using the first set of lines and the third set of lines; and
compensating transmissions for a CPE on the first set of lines based at least in part on the channel estimation, wherein the compensation is to reduce crosstalk between the first set of lines and the second set of lines.

2. The method of claim 1, further comprising:
using the channel estimation to reduce crosstalk for each CPE from the first set of CPEs.

3. The method of claim 2, wherein using the channel estimation to reduce crosstalk is based at least in part on receiving crosstalk information associated with crosstalk between the first set of CPEs and the second set of CPEs.

4. The method of claim 2, wherein using the channel estimation to reduce crosstalk comprises: constructing a vectoring matrix based at least in part on the virtualized lines, wherein the vectoring matrix comprises a member of a set consisting of: a precoding matrix and a canceller matrix.

5. The method of claim 4, wherein the vectoring matrix comprises a block diagonal matrix.

6. The method of claim 1, wherein communications of the first set of CPEs are time synchronized with communications of the second set of CPEs.

7. The method of claim 1, wherein the first set of CPEs are associated with a first operator and the second set of CPEs are associated with a second operator.

8. A method for wireline communication, comprising:
providing service by a first distribution point to a first set of consumer premises equipment (CPEs) over a first set of lines in a binder, wherein the binder further comprises a second set of lines associated with a second set of CPEs serviced by a second distribution point;
receiving crosstalk information associated with crosstalk between the first set of CPEs and the second set of CPEs without receiving data sent to or from the second set of CPEs; and
using the crosstalk information to reduce crosstalk between the first set of lines and the second set of lines.

9. The method of claim 8, wherein the crosstalk information comprises:
time synchronization information for synchronizing communications of the first set of CPEs with communications of the second set of CPEs.

10. The method of claim 9, wherein the time synchronization information comprises a time of day or a loop timing over a crosstalk channel.

11. The method of claim 8, further comprising:
downloading the crosstalk information from a server that is separate from the second set of CPEs.

12. The method of claim 8, wherein using the crosstalk information to reduce crosstalk comprises: constructing a vectoring matrix using a QR decomposition of a plurality of channel matrices, wherein the vectoring matrix is from a group consisting of: a precoding matrix and a canceller matrix; and
multiplying the vectoring matrix with a channel matrix, wherein the channel matrix is based at least in part on the received crosstalk information.

13. The method of claim 12, wherein the vectoring matrix comprises a block diagonal matrix.

14. The method of claim 8, wherein using the crosstalk information to reduce crosstalk comprises: constructing a vectoring matrix using an inverse or pseudoinverse of a plurality of channel matrices, wherein the vectoring matrix is from a group consisting of: a precoding matrix and a canceller matrix; and
multiplying the vectoring matrix with a channel matrix, wherein the channel matrix is based at least in part on the received crosstalk information.

15. The method of claim 8, wherein the crosstalk information is from a group consisting of: a downstream channel matrix, a pilot sequence assignment, a quadrant scrambler state, synchronization information associated with the first distribution point and the second distribution point, and a superframe alignment and synchronization symbol index.

16. The method of claim 8, wherein the first set of CPEs are associated with a first operator and the second set of CPEs are associated with a second operator.

17. A communication device for wireline communication, in a system comprising:
a processor;
memory in electronic communication with the processor; and
instructions stored in the memory and operable, when executed by the processor, to cause the communication device to:
provide service by a first distribution point to a first set of consumer premises equipment (CPEs) over a first set of lines in a binder, wherein the binder further comprises a second set of lines associated with a second set of CPEs serviced by a second distribution point;
virtualize a third set of lines at the first distribution point corresponding to the second set of CPEs;
obtain a channel estimation for each CPE of the first set of CPEs using the first set of lines and the third set of lines; and
compensate transmissions for a CPE on the first set of lines based at least in part on the channel estimation, wherein the compensation is to reduce crosstalk between the first set of lines and the second set of lines.

18. The communication device of claim 17, wherein the instructions are further executable by the processor to cause the communication device to:
use the channel estimation to reduce crosstalk for each CPE from the first set of CPEs.

19. The communication device of claim 18, wherein using the channel estimation to reduce crosstalk is based at least in part on receiving crosstalk information associated with crosstalk between the first set of CPEs and the second set of CPEs.

20. The communication device of claim 18, wherein using the channel estimation to reduce crosstalk comprises: constructing a vectoring matrix based at least in part on the virtualized lines, wherein the vectoring matrix comprises a member of a set consisting of: a precoding matrix and a canceller matrix.

21. The communication device of claim 20, wherein the vectoring matrix comprises a block diagonal matrix.

22. The communication device of claim 17, wherein communications of the first set of CPEs are time synchronized with communications of the second set of CPEs.

23. A communication device for wireline communication, in a system comprising:
a processor;
memory in electronic communication with the processor; and
instructions stored in the memory and operable, when executed by the processor, to cause the communication device to:
provide service by a first distribution point to a first set of consumer premises equipment (CPEs) over a first set of lines in a binder, wherein the binder further comprises a second set of lines associated with a second set of CPEs serviced by a second distribution point;
receive crosstalk information associated with crosstalk between the first set of CPEs and the second set of CPEs without receiving data sent to or from the second set of CPEs; and
use the crosstalk information to reduce crosstalk between the first set of lines and the second set of lines.

24. The communication device of claim 23, wherein the crosstalk information comprises: time synchronization information for synchronizing communications of the first set of CPEs with communications of the second set of CPEs.

25. The communication device of claim 24, wherein the time synchronization information comprises a time of day or a loop timing over a crosstalk channel.

26. The communication device of claim 23, wherein the instructions are further executable by the processor to cause the communication device to:
download the crosstalk information from a server that is separate from the second set of CPEs.

27. The communication device of claim 23, wherein the instructions executable by the processor to cause the communication device to use the crosstalk information to reduce crosstalk comprise instructions to:
construct a vectoring matrix using a QR decomposition of a plurality of channel matrices, wherein the vectoring matrix is from a group consisting of: a precoding matrix and a canceller matrix; and
multiply the vectoring matrix with a channel matrix, wherein the channel matrix is based at least in part on the received crosstalk information.

28. The communication device of claim 27, wherein the vectoring matrix comprises a block diagonal matrix.

29. The communication device of claim 23, wherein the instructions executable by the processor to cause the communication device to use the crosstalk information to reduce crosstalk comprise instructions to:
construct a vectoring matrix using an inverse or pseudoinverse of a plurality of channel matrices, wherein the vectoring matrix is from a group consisting of: a precoding matrix and a canceller matrix; and
multiply the vectoring matrix with a channel matrix, wherein the channel matrix is based at least in part on the received crosstalk information.

30. The communication device of claim 23, wherein the crosstalk information is from a group consisting of: a downstream channel matrix, a pilot sequence assignment, a quadrant scrambler state, synchronization information associated with the first distribution point and the second distribution point, and a superframe alignment and synchronization symbol index.
